(19) United States
(12) Patent Application Publication
(10) Pub. No.: US 2007/0274868 A1
(43) Pub. Date: Nov. 29, 2007

(54) Combustible gas pellistor

(75) Inventor: Kevin Brown, Notts (GB)

Correspondence Address: VENABLE LLP, P.O. BOX 34385, WASHINGTON, DC, 20043-9998, US

(73) Assignee: E2V Technologies (UK) Limited, Chelmsford (GB)

(21) Appl. No.: 11/798,332

(22) Filed: May 11, 2007

(30) Foreign Application Priority Data
May 11, 2006 (GB) GB0609353.8

(51) Int. Cl. G01N 31/12

(52) U.S. Cl. 422/94

(57) ABSTRACT

A gas sensor arrangement for detecting a combustible gas comprises a detector wire in thermal contact with a catalyst and a compensator wire. The wires are in the form of pellet resistors (pellistors) and in a constant current bridge arrangement. An electrical circuit connected to the detector wire and to the compensator wire is arranged to detect a difference between the resistance of the detector wire and the resistance of the compensator wire to provide an output signal to indicate the presence of a combustible gas. The electrical circuit is 15 further arranged to derive a correction signal from a measurement of the resistance of the compensator wire for correcting the output signal for temperature variation. The ambient temperature is thereby measured using the voltage across the compensator wire. The correction can be implemented in hardware or software.

### CROSS-REFERENCE TO RELATED APPLICATION

This application claims the priority of GB 0609353.8, filed May 11, 2006, the disclosure of which is incorporated herein by reference, along with each U.S. and foreign patent and patent application mentioned below.

### BACKGROUND

The present invention relates to gas sensors, in particular the type of gas sensors known as catalytic pellet resistors (pellistors).

Catalytic pellistors have been used for many years to detect levels of combustible gases and vapour in air. In brief, such sensors typically comprise a pair of coils, each embedded in a bead. One of the beads (the detector) is coated with an appropriate catalyst that reacts with a gas to be tested; the other bead (the compensator) is not coated with the catalyst. The coils are heated so that the catalyst coated bead reacts with the test gas, thereby raising the temperature further and increasing the resistance of the coil in the catalyzed bead. The difference in resistance between the detector and compensator coils is measured by a bridge circuit. It is known that the response of this type of sensor can change as the ambient temperature increases. This change can be seen as a change in the zero (i.e. the response in air) or a change in the net response to combustible gas.

It is possible to minimize the change in zero by closely matching the changes in resistance between the compensator and detector beads. This is relatively easy to do in constant current operation but is less easy, but still possible, in constant voltage operation of the bridge circuit. The effect of temperature on the net response to the combustible gas is an inherent property of the detector bead and results in a decrease in sensitivity as the ambient temperature increases. This change does not normally cause significant problems at ‘normal’ ambient temperatures. For example the performance standard EN 61779-4 (For Group 2 instruments reading up to 100% Lower Explosive Limit LEL of the flammable gas) for fixed apparatus states that the maximum variation at ±55 Deg C. shall not exceed ±10% of the measuring range or ±20% of the indication, whichever is the greater. However, there appears to be a trend for the performance testing temperature requirements to be increased and the allowed variation to be decreased. An example is the CSA performance standard C22-2-152 section 6.12.2 for fixed systems. In this the upper temperature has been increased to 75 degrees C., whilst the maximum allowed variation has been reduced to ±5% of full-scale reading.

The change in response of such sensors with temperature can be easily modeled and the response can be compensated (by increasing the gain in the sensor circuit) if the ambient temperature is known. Existing instrumentation does this by measuring the ambient temperature using a thermometer, either in the sensing head or in the instrument itself. This thermometer typically takes the form of a thermistor or thermocouple.

An example of the arrangement of a detector bead and a compensator bead is described in EP-A-0 231 973. In this arrangement, a compensator bead is used to additionally measure whether the concentration of gas is above an upper explosive limit (UEL) concentration at which point combustion on the detector bead would be quenched and the measurement of gas concentration would become inalccurate.

We have appreciated the need to improve the performance of gas sensors that use a detected increase in temperature due to catalytic reaction as the mechanism to detect a target gas. We have appreciated in particular the need to accurately and simply measure the ambient temperature to enable compensation for temperature variation.

### SUMMARY

An embodiment of the invention provides for a gas sensor arrangement for detecting a combustible gas, comprising: a detector wire in thermal contact with a catalyst and a compensator wire, an electrical circuit connected to the detector wire and to the compensator wire and arranged to detect a difference between the resistance of the detector wire and the resistance of the compensator wire to provide an output signal to indicate the presence of a combustible gas, the electrical circuit being further arranged to derive a correction signal from a measurement of the resistance of the compensator wire for correcting the output signal for temperature variation.

According to the above embodiment, circuitry is arranged to derive a correction signal from the resistance of a compensator wire. This allows the ambient temperature of the environment surrounding the detector wire and compensator wire to be determined and for an appropriate correction to be made to compensate for the loss of sensitivity when the sensor is used at high temperatures, such as around 200 Degrees C.

### BRIEF DESCRIPTION OF THE FIGURES

An embodiment of the invention will now be described by way of example only and with reference to the figures in which:

FIG. 1: shows a plan and side cross-section of a gas sensor which may embody the invention;

FIG. 2: shows a pellet resistor; and

FIG. 3: shows a bridge circuit which may embody the invention.

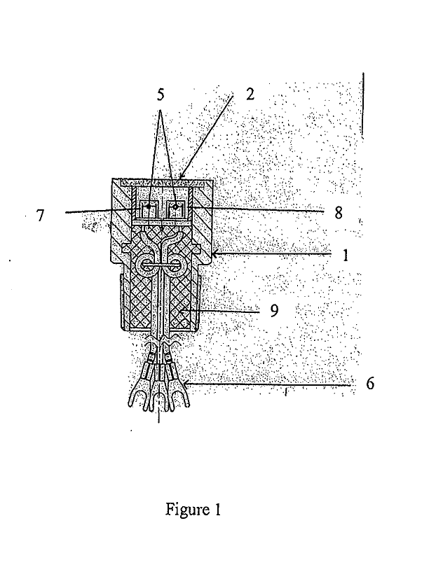

### DESCRIPTION OF A PREFERRED EMBODIMENT

The embodiment of the invention is a pellet resistor (known as a pellistor) type gas sensor. The physical arrangement of such a sensor will first be briefly described (this is well known to the skilled person).

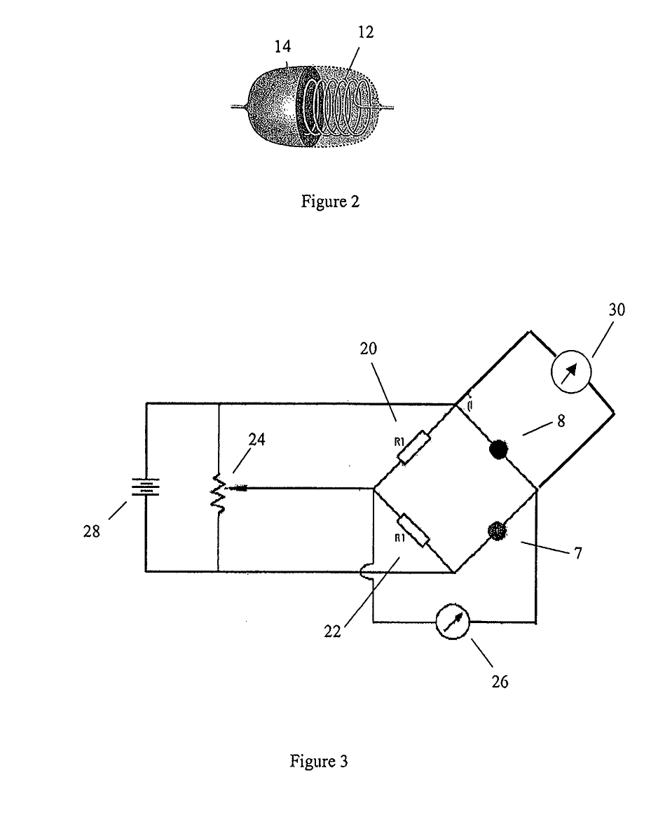

The gas sensor comprises a base 1 supporting a mesh or sintered metal 3 to form an enclosure. The rear of the enclosure may be sealed with a potting compound 9. Within the enclosure are a detecting element 7 and a compensator element 8. Each element comprises a metallic coil 5 embedded within an oxide to form a bead. The detecting bead is coated with a catalytic metal coating which may be of Palladium or Platinum. The compensator bead is coated with a non-catalytic compound. The wire coils are connected to circuitry via electrically conductive pins 4. The construction of the pellistors beads is shown in FIG. 2, which shows the filament wire 12 embedded in a metal oxide bead 14. The detecting and compensating beads are connected to circuitry via conductive leads 9, pins or other conductors.

The electrical circuit of the embodying sensor is shown in FIG. 3. The detector element 7 and compensator element 8 are connected in a bridge circuit with balance resistors R₁ 20, 22. A trim resistor 24 is provided to balance the circuit. A power source 28 is connected across the bridge circuit across two junctions and an output detector, here shown as a simple voltmeter 26, across the other two junctions. In practice, the output detector will comprise further circuitry, typically to provide a digital signal for analysis.

In operation, the trim resistor keeps the bridge balanced. A balanced bridge has no output signal. Resistor value R₁ and trim resistor 24 are selected with relatively large resistance values to ensure proper function of the circuit. When a gas burns on the active sensor surface of the detecting element 8, the heat of combustion causes the temperature of the element to rise, which in turn changes the resistance of the element. As the resistance of the bridge is unbalanced, the offset voltage is measured as the signal by voltmeter 26. It is important that the reference (compensator) bead maintains a substantially constant resistance during the exposure to the combustible gas; otherwise, the measured signal will be inaccurate. An additional resistor may be provided in parallel with the compensator bead for adjustment purposes.

The effect of changes of temperature on the pellistor beads is known. In a Wheatstone bridge type circuit, as described above, operated in constant voltage, a rise in ambient temperature increases both bead resistances. In a constant voltage circuit, this resistance increase causes a decrease in the current flowing through in the circuit. A change in the individual voltages is also seen and a positive change in one bead will be mirrored in a negative change in the other bead. This is also seen in the presence of combustible gas. In this case the voltage across the detector bead rises (due to the gas burning on the detector bead increasing its temperature and hence resistance) and since the bead pair or bridge voltage is fixed, then the compensator voltage must decrease. Hence the beads are interdependent on each other.

The circuit embodying the invention is operated with a constant current source 28. In the case of constant current, the voltages across the beads are not interdependent. Therefore both bead voltages are free to change with temperature. The voltage across the detector bead can rise within the presence of combustible gas, but the voltage across the compensator bead is unaffected by the change across the detector bead (apart from a small change due to the overall change in gas density). Any change in voltage across the compensator bead is therefore due to a change in ambient temperature and is essentially linear. Thus the voltage across the compensator can be used as a thermometer to measure the ambient temperature. There is a change in sensitivity with rising ambient temperature as the temperature change compared to the ambient temperature decreases. The change in the sensitivity of the sensor as a whole with temperature is known, and so the correct degree of compensation can be made. The correction of the output signal to compensate for change in temperature can be applied in further circuitry, here shown as a voltmeter 30. However, the correction signal obtained from the measurement of resistance of the compensator bead is preferably used to adjust the gain of the output signal in subsequent software processing, in which case the circuitry shown as a simple voltmeter will, in practice, be an analogue to digital converter. The voltage across the compensator is measured and the temperature figure is then calculated using an algorithm or look-up table. The measurement is done using a high impedance system and hence would not affect the rest of the Wheatstone bridge circuit. The technique in the embodiment of the invention becomes more and more important as the ambient temperature rises e.g. at temperatures of ˜200 Degrees Celsius the pellistor sensitivity can be reduced by ˜20%. The present technique would increase the chances of the performance standard temperatures to be able to be increased to well over 100 Degrees C. without the need for external temperature measuring sensors.

The appropriate outputs from the gas sensor are shown in FIG. 3 and may be provided by three output pins: two output pins for connection of the voltmeter 26 and one extra pin for the extra connection of the additional voltmeter 30.

A typical response to ambient temperature change of the compensator bead is varying linearly from 2.5 Ohms at 20 Degrees C. to 3 Ohms at 200 Degrees C. This linear response can be implemented in analogue circuitry, a DSP or a lookup table in software.

What is claimed is:

1. A gas sensor arrangement for detecting a combustible gas comprising a detector wire in thermal contact with a catalyst and a compensator wire, an electrical circuit connected to the detector wire and to the compensator wire and arranged to detect a difference between the resistance of the detector wire and the resistance of the compensator wire to provide an output signal to indicate the presence of a combustible gas, the electrical circuit being further arranged to derive a correction signal from a measurement of the resistance of the compensator wire for correcting the output signal for temperature variation.

2. A gas sensor arrangement according to claim 1, wherein the electrical circuit operates as a constant current circuit.

3. A gas sensor arrangement according to claim 1, wherein the electrical circuit comprises a bridge arrangement.

4. A gas sensor according to claim 3, wherein the detector wire and compensator wire are connected with the electrical circuit in a Wheatstone bridge arrangement with a constant current source across the detector wire and compensator wire.

5. A gas sensor according to claim 1, wherein the electrical circuit comprises an arrangement to compensate the output signal with respect to the correction signal.

6. A gas sensor according to claim 1, wherein the electrical circuit includes analogue to digital converters to convert to output signal and correction signal to respective digital signals for subsequent digital processing for correcting for temperature variation.

7. A gas sensor according to claim 1, wherein the detector and compensator wires are in beads in the form of pellistors.

8. A method of operating a gas sensor, the gas sensor comprising a detector wire in thermal contact with a catalyst and a compensator wire, the method comprising detecting a difference between the resistance of the detector wire and the resistance of the compensator wire to provide an output signal to indicate the presence of a combustible gas, and deriving a correction signal from a measurement of the resistance of the compensator wire for correcting the output signal for temperature variation.

9. A method according to claim 8, comprising providing a constant current through the detector wire and the compensator wire.

10. A method according to claim 8, comprising converting the output signal and correction signal to respective digital signals, and compensating the output signal with respect to the correction signal using digital signal processing.

11. A method according to claim 10, wherein the digital signal processing is implemented in software.
